(19) United States
(12) Patent Application Publication
(10) Pub. No.: US 2022/0337004 A1
(43) Pub. Date: Oct. 20, 2022

(54) Universal Serial Bus (USB) cable paddle card design for wire termination

(71) Applicant: Intel Corporation, Santa Clara, CA (US)

(72) Inventor: Xiang Li, Portland, OR (US)

(73) Assignee: Intel Corporation, Santa Clara, CA (US)

(21) Appl. No.: 17/854,436

(22) Filed: Jun. 30, 2022

(51) Int. Cl. H01R 13/66; H01R 24/60

(52) U.S. Cl. CPC H01R 13/6658; H01R 24/60; H01R 12/716

(57) ABSTRACT

Methods and apparatus relating to a Universal Serial Bus (USB) cable paddle card design for wire termination are described. In one embodiment, a cable paddle card includes: a first plug connector pad coupled to a first transmission line; a second plug connector pad coupled to a second transmission line; a third plug connector pad coupled to a third transmission line; and a fourth plug connector pad coupled to a fourth transmission line. The first transmission line and the second transmission line are to transmit signals received from a cable and the third transmission line and the fourth transmission line are to receive signals to be transmitted to the cable. Other embodiments are also claimed and disclosed.

### FIELD

The present disclosure generally relates to the field of electronics. More particularly, an embodiment relates to a Universal Serial Bus (USB) cable paddle card design for wire termination.

### BACKGROUND

Currently, Universal Serial Bus (USB) 4, Gen 3, is the latest version of USB. It can support a 40 Giga bits per second (Gbps) bandwidth. The 40 Gbps in USB4, Gen 3, is achieved by using two lanes to communicate data. However, the cable used has to be well-designed to meet the signal integrity requirements at high bandwidth rates. There are many steps to manufacture such a cable. The cable cost is significantly impacted by the cable manufacturing process.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1A shows an assembly for Universal Serial Bus (USB) cable.

FIG. 1B shows a plug connector pinout, which may be utilized in one or more embodiments.

FIG. 1C shows a top view of a sample USB plug.

FIG. 1D illustrates a top view of sample wire termination and Printed Circuit Board (PCB) routing for a USB plug.

FIG. 1E illustrates a sample crosstalk measurement for the cables of FIGS. 1C and 1D.

FIG. 2 shows the total crosstalk values used for USB4, Gen 3 cable, which may be used in one or more embodiments.

FIG. 3A illustrates a top view of USB4, Gen 3 cable wire termination.

FIG. 3B shows a top view of the paddle card of FIG. 3A.

FIG. 4A illustrates a top view of paddle card routing, according to an embodiment.

FIG. 4B illustrates a perspective view of the termination/soldering pads of the paddle card of FIG. 4A, according to an embodiment.

FIG. 5 illustrates a block diagram of an embodiment of a computing system, which may be utilized in various embodiments discussed herein.

FIG. 6 illustrates a block diagram of an embodiment of a computing system, which may be utilized in various embodiments discussed herein.

FIG. 7 illustrates various components of a processer in accordance with some embodiments.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, to provide a high-bandwidth USB connection (e.g., for USB4, Gen 3), cable cost is significantly increased due to the complicated cable manufacturing process. To this end, some embodiments relate to a Universal Serial Bus (USB) cable paddle card design for wire termination. Cables designed in accordance with such embodiments are able to support USB4, Gen 3, at a lower manufacturing cost.

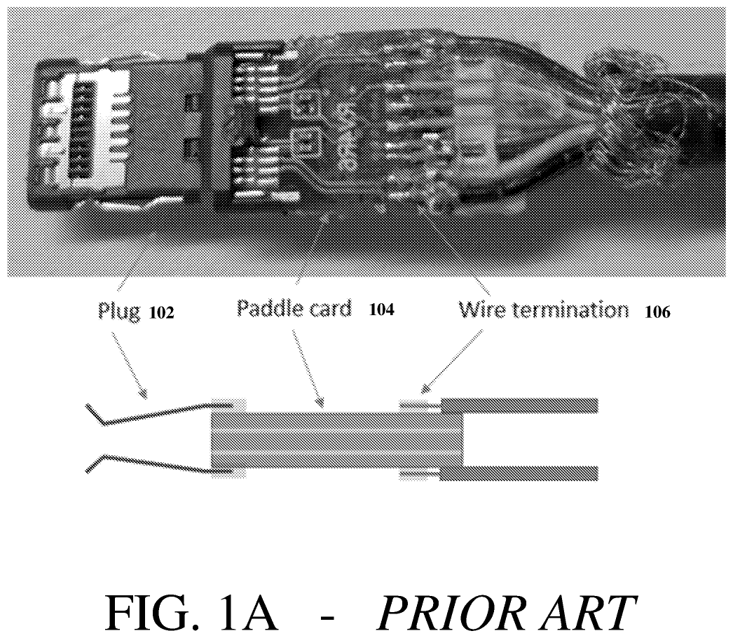

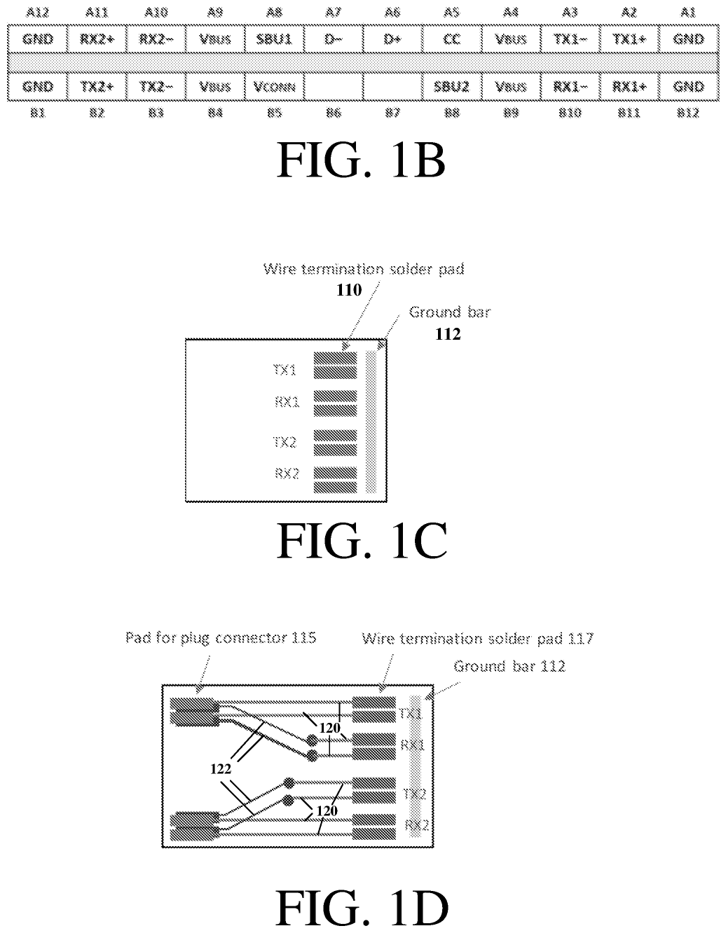

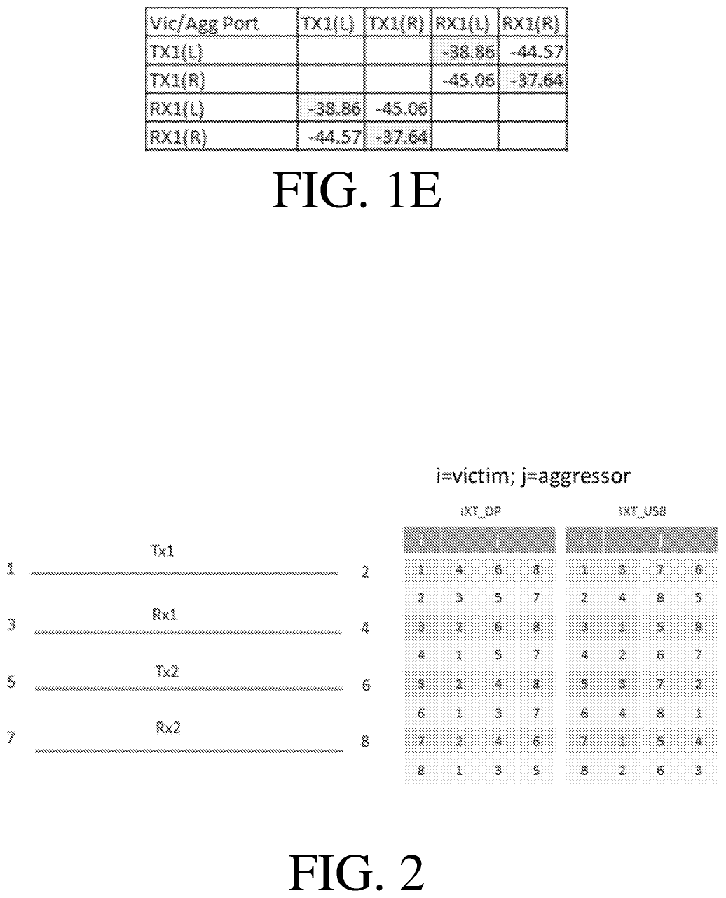

FIG. 1A shows an assembly for a USB cable. The top portion of FIG. 1A illustrates a top view of the cable and the bottom portion of FIG. 1A shows a side view of the card. As shown, a plug connector 102 is soldered on a paddle card 104 on one end (left side of FIG. 1A) and cable wire termination 106 is provided on the other side of the paddle card 104 (the right side of FIG. 1A). Both plug and wire are soldered on the paddle card. Printed Circuit Board (PCB) trace routing on the paddle card 104 may be used to connect the plug connector to wire termination. As discussed herein, “wire termination” generally refers to soldering a wire to provide an electrical contact.

FIG. 1B shows a plug connector pinout, which may be utilized in one or more embodiments. This pinout may be used for a USB type C (USB-C) plug. Pins Ax and Bx may be placed on opposite sides of a paddle card. As shown, each transmission line can be implemented with a differential (labeled as “Diff” in the figures) pair of wires, including for example, TX1/TX2 for transmit lines/wires and RX1/RX2 for receive lines/wires, e.g., where TX1+ and TX1− form a differential pair for TX1 and so on.

FIG. 1C shows a top view of a sample USB plug. As shown in FIG. 1C, four differential pairs are placed on the same side of the plug connection and soldered 110. The plug also includes a ground bar 112.

FIG. 1D illustrates a top view of sample wire termination and PCB routing for a USB plug. As shown in FIG. 1D, TX1 and RX2 differential wire pairs are placed on the top side of the plug connection, while RX1 and TX2 differential wire pairs are placed on the bottom side for plug connection. The ground bar 112 is also present as shown in FIG. 1D. The pads for plug connectors 115 are used to couple the plug to a device and wire termination solder pads 117 are used to couple signals from a USB cable to the plug.

Generally, a micro-coax (or a coax/coaxial cable) or another coax or coaxial (e.g., Radio Grade 6 (RG6)) cable can be used for high-speed differential wire pairs. Soldering of micro-coax can be the most complicated step for cable manufacturing. There are generally several steps needed for micro-coax soldering, including wire arrangement, wire striping, signal pin soldering, ground soldering and inspection.

For the cable in FIG. 1C, all high-speed signals are placed on the top side, in such way, one setup is used to cover all micro-coax soldering. The low-speed signals and power wires can be soldered on the bottom side of the plug; hence, the wire termination of low-speed signals is relatively simple. For the cable in FIG. 1D, some wire traces are on top 120, whereas other traces are on the bottom 122 (e.g., through the PCB).

FIG. 1E illustrates a sample crosstalk measurement for the cables of FIGS. 1C and 1D. The cable of FIG. 1D may have a lower near end crosstalk (NEXT) than the cable of FIG. 1C. In both configurations, TX1 and RX1 are placed next to each other. As a result, the NEXT (db) is relatively high and the far end crosstalk (FEXT) is low. The same result is identified for TX2 and RX2 pairs.

USB4, Gen 3, specifies the combined total crosstalk in USB mode and DP alt-mode as follows: (i) USB mode: 2 NEXT +1 FEXT; and (ii) Display Port (DP) mode: 3 FEXT. The DP mode is also sometimes referred to as “DP Alt Mode.”

FIG. 2 shows the total crosstalk values used for USB4, Gen 3 cable, which may be used in one or more embodiments. As can be seen, the DP mode only needs to control the FEXT, the cable shown in FIG. 1D is able to meet the DP mode requirement. However, the USB mode needs to control the NEXT between TX and RX. The high crosstalk of the cables shown in FIGS. 1C and 1D cannot meet the USB mode total crosstalk requirement. Accordingly, the cable shown in FIGS. 1C and 1D cannot meet USB4, Gen 3, compliance requirements due to high NEXT between TX and RX pairs.

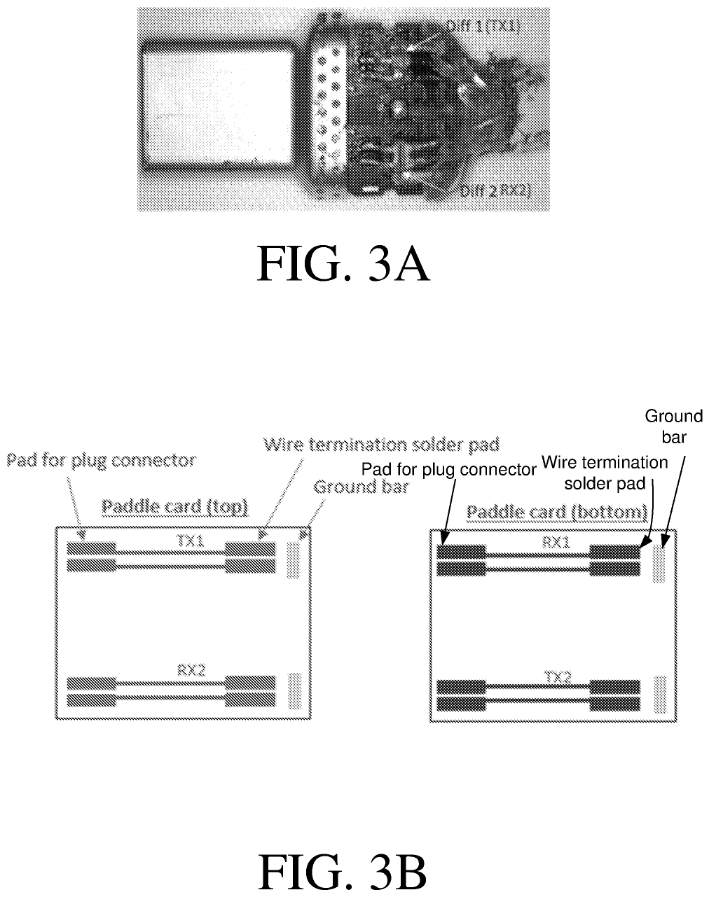

FIG. 3A illustrates a top view of USB4, Gen 3 cable wire termination. To address the issues discussed before, TX1s and RX2 are kept on the front side of the paddle card. RX1 and TX2 are provided on the back side of the paddle card. As a result, TX and RX transmission lines are well-separated to reduce NEXT.

FIG. 3B shows a top view of the paddle card of FIG. 3A. As labeled, the left side of FIG. 3B shows the top side of the paddle card and the right side of FIG. 3B shows the bottom side of the paddle card.

Separating the four differential transmission line/wire pairs on both sides can help to reduce the NEXT between TX and RX transmission lines. This approach also requires two setups to solder the coax cables on both sides to the connector. These additional steps of manufacturing process may add approximately 15% to the cost of the final cable assembly.

To address this issue, at least one embodiment provides all high-speed differential transmission line pairs on the same side for wire termination/soldering. The TX and RX placement is also modified by keeping TX1/TX2 wire termination/soldering next to each other and RX1/RX2 wire termination/soldering next to each other. A ground bar may be additionally used to separate TX soldering pads and RX soldering pads to reduce the NEXT.

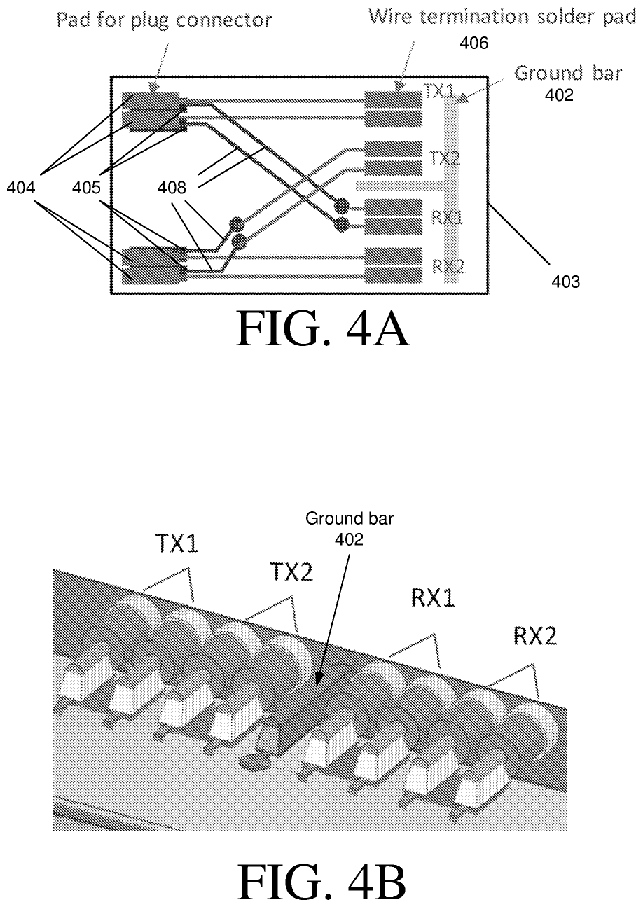

FIG. 4A illustrates a top view of paddle card routing, according to an embodiment. In such an embodiment, only TX1/TX2 and RX1/RX2 transmission line pairs may have a high NEXT, but the high NEXT of TX1/TX2 and RX1/RX2 will not impact either USB4 mode or DP mode performance (e.g., due to the ground bar 402 that electro-magnetically isolates the TX2 and RX1 pads).

Moreover, one or more embodiments simplify the cable manufacturing process to reduce the cable assembly costs with equivalent performance of some USB4 , Gen 3 cable designs. In one embodiment, for a plug connector of the paddle card 403, TX1 and RX2 plug connector pads 404 are placed on the top side of the paddle card 403, and RX1 and TX2 plug connector pads 405 are placed on the bottom side of the paddle card 403 (such as shown in FIG. 4A). While some embodiments indicate a first set of connections on the top side of the paddle card and a second set of connections on the bottom side of the paddle card, embodiments are not limited to this and these sides can be reversed.

On the wire termination/soldering side 406, TX1 and TX2 wires are placed together on the top side. RX1 and RX2 wires are placed together on the top side as well. The ground bar 402 is used to solder the micro-coax cable ground wire. As shown, the ground bar 402 is extended between TX2 and RX1 solder pads 406. PCB routing may be used for RX1 and TX2 wires as shown in FIG. 4A.

FIG. 4B illustrates a perspective view of the termination/soldering pads of the paddle card of FIG. 4A, according to an embodiment.

For USB4 , Gen 3, USB mode only needs to control the NEXT between TX and RX transmission lines. The high TX1/TX2 NEXT and RX1/RX2 NEXT will not impact the total crosstalk. Moreover, in the total crosstalk calculation, only NEXT of TX/RX, FEXT of TX/TX, and FEXT of RX/RX are counted for the USB mode. The NEXT between TX2 and RX1 is much lower due to shielding of ground bar 402. Further, there is no need to control the NEXT for DP model as previously discussed. According, the new design of one or more embodiments can meet the USB4 , Gen 3, requirements with both a simplified manufacturing process and driving the cable cost down by approximately 15 percent.

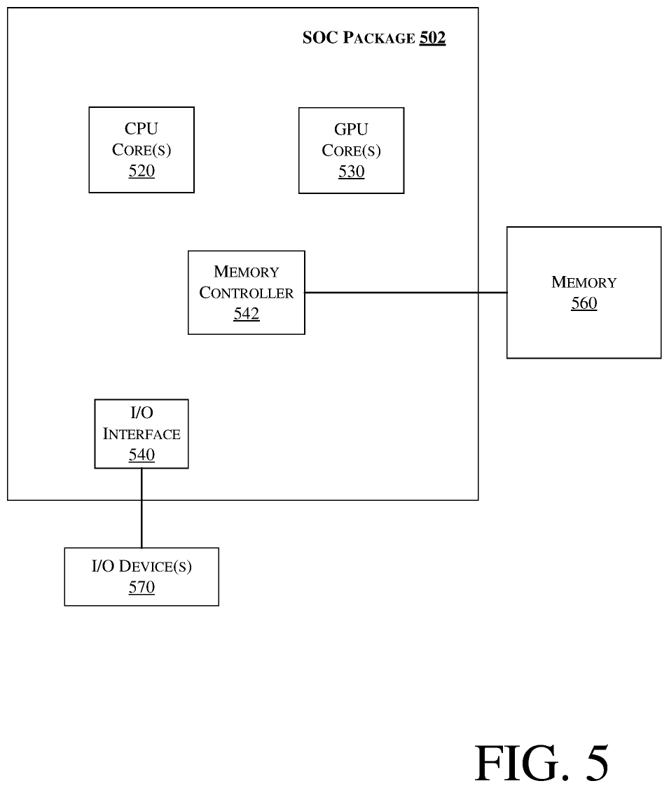

One or more components discussed with reference to FIGS. 5-7 (including but not limited to I/O devices, memory/storage devices, graphics/processing cards/devices, network/bus/audio/display/graphics controllers, wireless transceivers, etc.) may be coupled using the USB connector designs discussed above. More particularly, FIG. 5 illustrates a block diagram of an SOC package in accordance with an embodiment. As illustrated in FIG. 5, SOC 502 includes one or more Central Processing Unit (CPU) cores 520, one or more Graphics Processor Unit (GPU) cores 530, an Input/Output (I/O) interface 540, and a memory controller 542. Various components of the SOC package 502 may be coupled to an interconnect or bus such as discussed herein with reference to the other figures. Also, the SOC package 502 may include more or less components, such as those discussed herein with reference to the other figures. Further, each component of the SOC package 520 may include one or more other components, e.g., as discussed with reference to the other figures herein. In one embodiment, SOC package 502 (and its components) is provided on one or more Integrated Circuit (IC) die, e.g., which are packaged into a single semiconductor device.

As illustrated in FIG. 5, SOC package 502 is coupled to a memory 560 via the memory controller 542. In an embodiment, the memory 560 (or a portion of it) can be integrated on the SOC package 502.

The I/O interface 540 may be coupled to one or more I/O devices 570, e.g., via an interconnect and/or bus such as discussed herein with reference to other figures. I/O device(s) 570 may include one or more of a keyboard, a mouse, a touchpad, a display, an image/video capture device (such as a camera or camcorder/video recorder), a touch screen, a speaker, or the like.

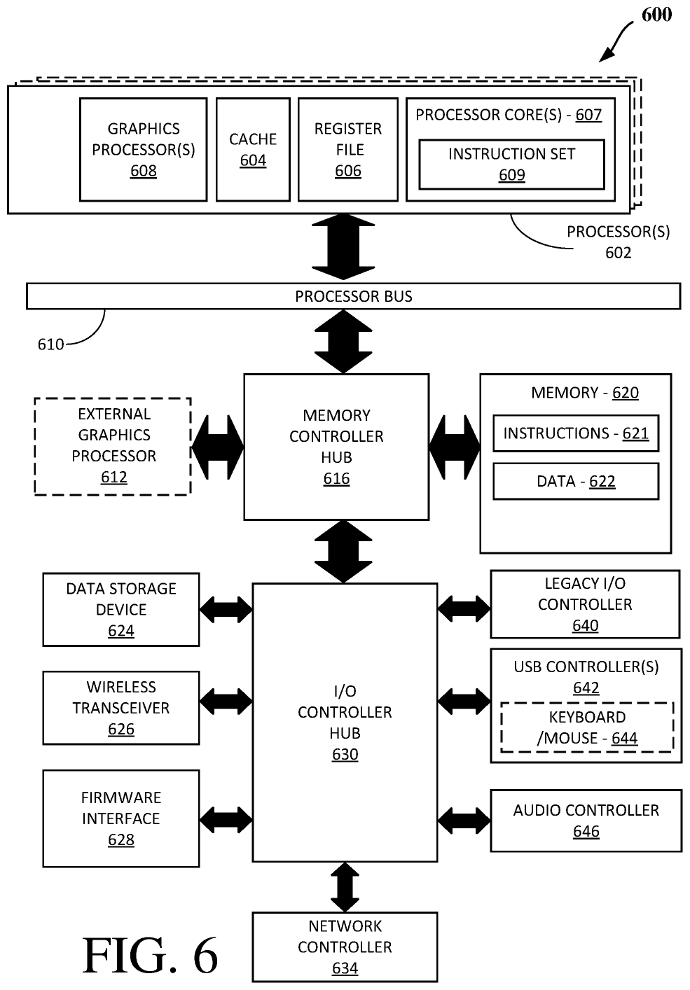

FIG. 6 is a block diagram of a processing system 600, according to an embodiment. In various embodiments the system 600 includes one or more processors 602 and one or more graphics processors 608, and may be a single processor desktop system, a multiprocessor workstation system, or a server system having a large number of processors 602 or processor cores 607. In on embodiment, the system 600 is a processing platform incorporated within a system-on-a-chip (SoC or SOC) integrated circuit for use in mobile, handheld, or embedded devices.

An embodiment of system 600 can include, or be incorporated within a server-based gaming platform, a game console, including a game and media console, a mobile gaming console, a handheld game console, or an online game console. In some embodiments system 600 is a mobile phone, smart phone, tablet computing device or mobile Internet device. Data processing system 600 can also include, couple with, or be integrated within a wearable device, such as a smart watch wearable device, smart eyewear device, augmented reality device, or virtual reality device. In some embodiments, data processing system 600 is a television or set top box device having one or more processors 602 and a graphical interface generated by one or more graphics processors 608.

In some embodiments, the one or more processors 602 each include one or more processor cores 607 to process instructions which, when executed, perform operations for system and user software. In some embodiments, each of the one or more processor cores 607 is configured to process a specific instruction set 609. In some embodiments, instruction set 609 may facilitate Complex Instruction Set Computing (CISC), Reduced Instruction Set Computing (RISC), or computing via a Very Long Instruction Word (VLIW). Multiple processor cores 607 may each process a different instruction set 609, which may include instructions to facilitate the emulation of other instruction sets. Processor core 607 may also include other processing devices, such a Digital Signal Processor (DSP).

In some embodiments, the processor 602 includes cache memory 604. Depending on the architecture, the processor 602 can have a single internal cache or multiple levels of internal cache. In some embodiments, the cache memory is shared among various components of the processor 602. In some embodiments, the processor 602 also uses an external cache (e.g., a Level-3 (L3) cache or Last Level Cache (LLC)) (not shown), which may be shared among processor cores 607 using known cache coherency techniques. A register file 606 is additionally included in processor 602 which may include different types of registers for storing different types of data (e.g., integer registers, floating point registers, status registers, and an instruction pointer register). Some registers may be general-purpose registers, while other registers may be specific to the design of the processor 602.

In some embodiments, processor 602 is coupled to a processor bus 610 to transmit communication signals such as address, data, or control signals between processor 602 and other components in system 600. In one embodiment the system 600 uses an exemplary ‘hub’ system architecture, including a memory controller hub 616 and an Input Output (I/O) controller hub 630. A memory controller hub 616 facilitates communication between a memory device and other components of system 600, while an I/O Controller Hub (ICH) 630 provides connections to I/O devices via a local I/O bus. In one embodiment, the logic of the memory controller hub 616 is integrated within the processor.

Memory device 620 can be a dynamic random access memory (DRAM) device, a static random access memory (SRAM) device, flash memory device, phase-change memory device, or some other memory device having suitable performance to serve as process memory. In one embodiment the memory device 620 can operate as system memory for the system 600, to store data 622 and instructions 621 for use when the one or more processors 602 executes an application or process. Memory controller hub 616 also couples with an optional external graphics processor 612, which may communicate with the one or more graphics processors 608 in processors 602 to perform graphics and media operations.

In some embodiments, ICH 630 enables peripherals to connect to memory device 620 and processor 602 via a high-speed I/O bus. The I/O peripherals include, but are not limited to, an audio controller 646, a firmware interface 628, a wireless transceiver 626 (e.g., Wi-Fi, Bluetooth), a data storage device 624 (e.g., hard disk drive, flash memory, etc.), and a legacy I/O controller 640 for coupling legacy (e.g., Personal System 2 (PS/2)) devices to the system. One or more Universal Serial Bus (USB) controllers 642 connect input devices, such as keyboard and mouse 644 combinations. A network controller 634 may also couple to ICH 630. In some embodiments, a high-performance network controller (not shown) couples to processor bus 610. It will be appreciated that the system 600 shown is exemplary and not limiting, as other types of data processing systems that are differently configured may also be used. For example, the I/O controller hub 630 may be integrated within the one or more processor 602, or the memory controller hub 616 and I/O controller hub 630 may be integrated into a discreet external graphics processor, such as the external graphics processor 612.

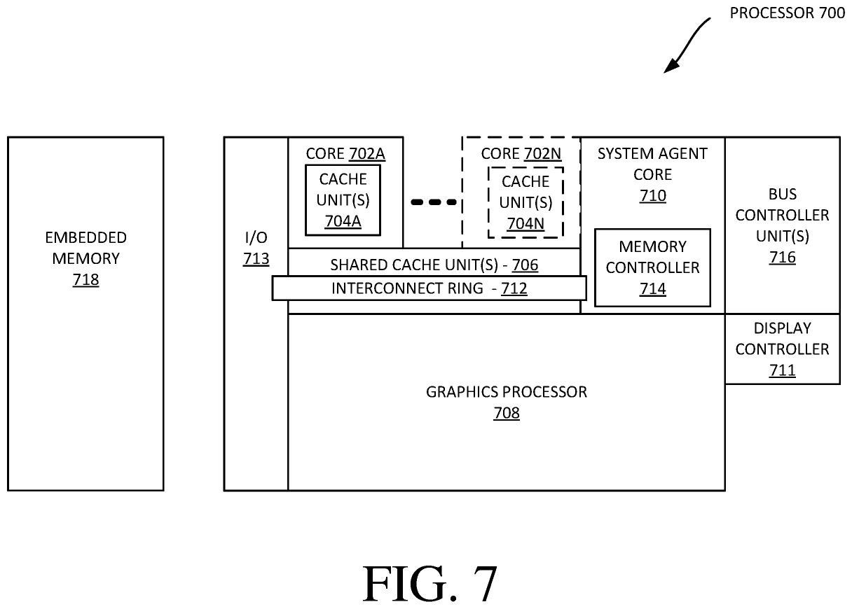

FIG. 7 is a block diagram of an embodiment of a processor 700 having one or more processor cores 702A to 702N, an integrated memory controller 714, and an integrated graphics processor 708. Those elements of FIG. 7 having the same reference numbers (or names) as the elements of any other figure herein can operate or function in any manner similar to that described elsewhere herein, but are not limited to such. Processor 700 can include additional cores up to and including additional core 702N represented by the dashed lined boxes. Each of processor cores 702A to 702N includes one or more internal cache units 704A to 704N. In some embodiments each processor core also has access to one or more shared cached units 706.

The internal cache units 704A to 704N and shared cache units 706 represent a cache memory hierarchy within the processor 700. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 706 and 704A to 704N.

In some embodiments, processor 700 may also include a set of one or more bus controller units 716 and a system agent core 710. The one or more bus controller units 716 manage a set of peripheral buses, such as one or more Peripheral Component Interconnect buses (e.g., PCI, PCI Express). System agent core 710 provides management functionality for the various processor components. In some embodiments, system agent core 710 includes one or more integrated memory controllers 714 to manage access to various external memory devices (not shown).

In some embodiments, one or more of the processor cores 702A to 702N include support for simultaneous multi-threading. In such embodiment, the system agent core 710 includes components for coordinating and operating cores 702A to 702N during multi-threaded processing. System agent core 710 may additionally include a power control unit (PCU), which includes logic and components to regulate the power state of processor cores 702A to 702N and graphics processor 708.

In some embodiments, processor 700 additionally includes graphics processor 708 to execute graphics processing operations. In some embodiments, the graphics processor 708 couples with the set of shared cache units 706, and the system agent core 710, including the one or more integrated memory controllers 714. In some embodiments, a display controller 711 is coupled with the graphics processor 708 to drive graphics processor output to one or more coupled displays. In some embodiments, display controller 711 may be a separate module coupled with the graphics processor via at least one interconnect, or may be integrated within the graphics processor 708 or system agent core 710.

In some embodiments, a ring-based interconnect unit 712 is used to couple the internal components of the processor 700. However, an alternative interconnect unit may be used, such as a point-to-point interconnect, a switched interconnect, or other techniques, including techniques well known in the art. In some embodiments, graphics processor 708 couples with the ring interconnect 712 via an I/O link 713.

The exemplary I/O link 713 represents at least one of multiple varieties of I/O interconnects, including an on package I/O interconnect which facilitates communication between various processor components and a high-performance embedded memory module 718, such as an eDRAM (or embedded DRAM) module. In some embodiments, each of the processor cores 702 to 702N and graphics processor 708 use embedded memory modules 718 as a shared Last Level Cache.

In some embodiments, processor cores 702A to 702N are homogenous cores executing the same instruction set architecture. In another embodiment, processor cores 702A to 702N are heterogeneous in terms of instruction set architecture (ISA), where one or more of processor cores 702A to 702N execute a first instruction set, while at least one of the other cores executes a subset of the first instruction set or a different instruction set. In one embodiment processor cores 702A to 702N are heterogeneous in terms of microarchitecture, where one or more cores having a relatively higher power consumption couple with one or more power cores having a lower power consumption. Additionally, processor 700 can be implemented on one or more chips or as an SoC integrated circuit having the illustrated components, in addition to other components.

The following examples pertain to further embodiments. Example 1 includes a cable paddle card comprising: a first plug connector pad coupled to a first transmission line; a second plug connector pad coupled to a second transmission line; a third plug connector pad coupled to a third transmission line; and a fourth plug connector pad coupled to a fourth transmission line, wherein the first transmission line and the second transmission line are to transmit signals received from a cable, wherein the third transmission line and the fourth transmission line are to receive signals to be transmitted to the cable, wherein the first plug connector pad and the fourth plug connector pad are to be located on a first side of the cable plug connector paddle card and the second plug connector pad and the third plug connector pad are to be located on a second side of the cable paddle card. Example 2 includes the cable paddle card of example 1, wherein the first plug connector pad, second plug connector pad, third plug connector pad, and fourth plug connector pad are to electrically couple the cable paddle card to a device.

Example 3 includes the cable paddle card of example 1, further comprising: a first termination pad coupled to the first transmission line; a second termination pad coupled to the second transmission line; a third termination pad coupled to the third transmission line; and a fourth termination pad coupled to the fourth transmission line. Example 4 includes the cable paddle card of example 3, wherein the first termination pad, the second termination pad, the third termination pad, and the fourth termination pad are to electrically couple the cable paddle card to the cable. Example 5 includes the cable paddle card of example 3, further comprising a ground bar to be located between the second termination pad and the third termination pad, wherein the ground bar is to electro-magnetically isolate the second termination pad and the third termination pad. Example 6 includes the cable paddle card of example 3, wherein the first termination pad, the second termination pad, the third termination pad, and the fourth termination pad are to be soldered to a Printed Circuit Board (PCB). Example 7 includes the cable paddle card of example 6, wherein the PCB is to route the second transmission line between the second termination pad and the second pad, wherein the PCB is to route the third transmission line between the third termination pad and the third pad.

Example 8 includes the cable paddle card of example 3, wherein the first pad, the second pad, the third pad, and the fourth pads are electrically coupled to a PCB. Example 9 includes the cable paddle card of example 8, wherein the PCB is to route the second transmission line between the second termination pad and the second pad, wherein the PCB is to route the third transmission line between the third termination pad and the third pad. Example 10 includes the cable paddle card of example 1, wherein the first pad, the second pad, the third pad, and the fourth pads are electrically coupled to a PCB. Example 11 includes the cable paddle card of example 1, wherein the cable comprises a coaxial cable. Example 12 includes the cable paddle card of example 11, wherein the cable comprises one of: a coaxial Radio Grade 6 (RG6) cable and a micro-coaxial cable. Example 13 includes the cable paddle card of example 1, wherein the cable paddle card is a Universal Serial Bus (USB) cable paddle card. Example 14 includes the cable paddle card of example 13, wherein the USB cable paddle card is a USB4, Gen 3 cable paddle card. Example 15 includes the cable paddle card of example 1, wherein each of the first transmission line, the second transmission line, the third transmission line, and the fourth transmission line is a differential transmission line.

Example 16 includes a system comprising: a motherboard having a connector to receive a cable paddle card; and the cable paddle card including: a first plug connector pad coupled to a first transmission line; a second plug connector pad coupled to a second transmission line; a third plug connector pad coupled to a third transmission line; and a fourth plug connector pad coupled to a fourth transmission line, wherein the first transmission line and the second transmission line are to transmit signals received from a cable, wherein the third transmission line and the fourth transmission line are to receive signals to be transmitted to the cable, wherein the first plug connector pad and the fourth plug connector pad are to be located on a first side of the cable plug connector paddle card and the second plug connector pad and the third plug connector pad are to be located on a second side of the cable paddle card.

Example 17 includes the system of example 16, wherein the first plug connector pad, second plug connector pad, third plug connector pad, and fourth plug connector pad are to electrically couple the cable paddle card to a device. Example 18 includes the system of example 16, further comprising: a first termination pad coupled to the first transmission line; a second termination pad coupled to the second transmission line; a third termination pad coupled to the third transmission line; and a fourth termination pad coupled to the fourth transmission line. Example 19 includes the system of example 16, wherein the cable comprises a coaxial cable. Example 20 includes the system of example 16, further comprising a processor, having one or more processor cores, wherein the processor is to communicate with a device via the cable paddle card. Example 21 includes an apparatus comprising means to perform a method as set forth in any preceding example.

In various embodiments, the operations discussed herein, e.g., with reference to FIG. 1 et seq., may be implemented as hardware (e.g., logic circuitry or more generally circuitry or circuit), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIG. 1 et seq.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. A cable paddle card comprising:
a first plug connector pad coupled to a first transmission line;
a second plug connector pad coupled to a second transmission line;
a third plug connector pad coupled to a third transmission line; and
a fourth plug connector pad coupled to a fourth transmission line,
wherein the first transmission line and the second transmission line are to transmit signals received from a cable, wherein the third transmission line and the fourth transmission line are to receive signals to be transmitted to the cable, wherein the first plug connector pad and the fourth plug connector pad are to be located on a first side of the cable plug connector paddle card and the second plug connector pad and the third plug connector pad are to be located on a second side of the cable paddle card.

2. The cable paddle card of claim 1, wherein the first plug connector pad, second plug connector pad, third plug connector pad, and fourth plug connector pad are to electrically couple the cable paddle card to a device.

3. The cable paddle card of claim 1, further comprising:
a first termination pad coupled to the first transmission line;
a second termination pad coupled to the second transmission line;
a third termination pad coupled to the third transmission line; and
a fourth termination pad coupled to the fourth transmission line.

4. The cable paddle card of claim 3, wherein the first termination pad, the second termination pad, the third termination pad, and the fourth termination pad are to electrically couple the cable paddle card to the cable.

5. The cable paddle card of claim 3, further comprising a ground bar to be located between the second termination pad and the third termination pad, wherein the ground bar is to electro-magnetically isolate the second termination pad and the third termination pad.

6. The cable paddle card of claim 3, wherein the first termination pad, the second termination pad, the third termination pad, and the fourth termination pad are to be soldered to a Printed Circuit Board (PCB).

7. The cable paddle card of claim 6, wherein the PCB is to route the second transmission line between the second termination pad and the second pad, wherein the PCB is to route the third transmission line between the third termination pad and the third pad.

8. The cable paddle card of claim 3, wherein the first pad, the second pad, the third pad, and the fourth pads are electrically coupled to a PCB.

9. The cable paddle card of claim 8, wherein the PCB is to route the second transmission line between the second termination pad and the second pad, wherein the PCB is to route the third transmission line between the third termination pad and the third pad.

10. The cable paddle card of claim 1, wherein the first pad, the second pad, the third pad, and the fourth pads are electrically coupled to a PCB.

11. The cable paddle card of claim 1, wherein the cable comprises a coaxial cable.

12. The cable paddle card of claim 11, wherein the cable comprises one of: a coaxial Radio Grade 6 (RG6) cable and a micro-coaxial cable.

13. The cable paddle card of claim 1, wherein the cable paddle card is a Universal Serial Bus (USB) cable paddle card.

14. The cable paddle card of claim 13, wherein the USB cable paddle card is a USB4, Gen 3 cable paddle card.

15. The cable paddle card of claim 1, wherein each of the first transmission line, the second transmission line, the third transmission line, and the fourth transmission line is a differential transmission line.

16. A system comprising:
a motherboard having a connector to receive a cable paddle card; and
the cable paddle card including:
a first plug connector pad coupled to a first transmission line;
a second plug connector pad coupled to a second transmission line;
a third plug connector pad coupled to a third transmission line; and
a fourth plug connector pad coupled to a fourth transmission line,
wherein the first transmission line and the second transmission line are to transmit signals received from a cable, wherein the third transmission line and the fourth transmission line are to receive signals to be transmitted to the cable, wherein the first plug connector pad and the fourth plug connector pad are to be located on a first side of the cable plug connector paddle card and the second plug connector pad and the third plug connector pad are to be located on a second side of the cable paddle card.

17. The system of claim 16, wherein the first plug connector pad, second plug connector pad, third plug connector pad, and fourth plug connector pad are to electrically couple the cable paddle card to a device.

18. The system of claim 16, further comprising:
a first termination pad coupled to the first transmission line;
a second termination pad coupled to the second transmission line;
a third termination pad coupled to the third transmission line; and
a fourth termination pad coupled to the fourth transmission line.

19. The system of claim 16, wherein the cable comprises a coaxial cable.

20. The system of claim 16, further comprising a processor, having one or more processor cores, wherein the processor is to communicate with a device via the cable paddle card.
